(19) United States
(12) Patent Application Publication
(10) Pub. No.: US 2003/0208406 A1
(43) Pub. Date: Nov. 6, 2003

(54) Method and apparatus for processing one or more value bearing instruments

(76) Inventors: Steve Atsushi Okamoto, Torrance, CA (US); Steven Miller Schattmaier, Irvine, CA (US); Tim Von Kaenel, Cote De Caza, CA (US); Mike Todd Zeile, Valencia, CA (US); Frederick C St Amour, Dana Point, CA (US)

Correspondence Address: SIDLEY AUSTIN BROWN & WOOD LLP, 717 NORTH HARWOOD, SUITE 3400, DALLAS, TX, 75201, US

(21) Appl. No.: 10/240,253

(22) PCT Filed: Mar. 28, 2001
(86) PCT No.: PCT/US01/10648

(51) Int. Cl. G06F 17/60

(52) U.S. Cl. 705/18

(57) ABSTRACT

A computer-implemented system provides secure distribution of value-bearing instruments, such as coupons, tickets, gift certificates, money orders and traveler's checks. The distribution system involves three parties which are the consumer of the instrument, the supplier of the instrument and a security party which is referred to as a secure transaction service. The consumer registers with the secure transaction service for identity verification either before or after a transaction is initiated with the supplier of products or services. Verification of the consumer's identity can be established at any required level. In one aspect of the system, the supplier provides the consumer with a confirmation token which the consumer must then provide to the secure transaction service together with identification information of the consumer, so that only the valid consumer can complete the transaction. By use of the confirmation token, the secure transaction service can obtain information, through either data pulling or pushing, from the product or service supplier. In certain cases, the secure transaction service generates the required product in an electronic form and securely transmits it to the validated consumer. Digital signatures can be used throughout the process to assure the integrity of the data and the identity of the sender. Other aspects of the system include the maintenance of funds for payment, multiple methods for verification of products which are issued and then validated at a verification site, as well as methods for reissuing, exchanging and forwarding value bearing instruments for original and third party users.

### BACKGROUND OF THE INVENTION

1. Field of the Invention

This invention relates to the field of computer software, and more particularly to a method and apparatus for processing a value-bearing instrument.

2. Background

A. Value Bearing Instruments

A value-bearing instrument is an item that has an intrinsic value and thereby represents a right to a valued item or service. Examples of such value-bearing instruments include currency, coupons, tickets, gift certificates, money order, and traveler's checks. A problem with value-bearing instruments is that it is inconvenient to transfer such instruments from one party to another. In most instances value-bearing instruments are exchanged via a physical transfer of the instrument itself. For example, a donor gives a gift certificate to a recipient by physically providing it to the recipient. Thus, there is a need for a system that allows users to transfer an authenticated version of a value-bearing instrument from one party to another without requiring that a physical version of the instrument be exchanged and/or forwarded to the recipient.

Most commercial transactions involve the use of value-bearing instruments. A problem with such transactions is that current value-bearing instruments lack flexibility. For example, transferring a value-bearing instrument (e.g., a concert ticket) requires the holder of the instrument to physically send the value-bearing instrument to the recipient. If, after receipt, the value-bearing instrument is lost or destroyed the recipient has little recourse. In some instances, loss of the value-bearing instrument results in a permanent depravation of the right associated with the instrument.

Modern commerce lacks a secure and convenient form for creating, storing, and managing value-bearing instruments. Current methods to reissue, transfer, resell, void, and verify value-bearing instruments are fraught with security and management problems. As a result, there is a need for a system that provides a mechanism to generate and manage value-bearing instruments. Current systems, for example, lack a method for regenerating and/or revoking authenticated copies of a value-bearing instrument. Additionally, such systems lack a method for managing the organization, assignment, and printing of such instruments. A user cannot, for example, print an authenticated version of a value-bearing instrument from a personal computer.

Current mechanisms for managing value-bearing instruments are configured to generate one original. Such systems do not retain a digital representation of the value-bearing instrument that may be subsequently modified, transferred, and/or managed via a network interface.

B. General Background Material About Computer Networks

In order to facilitate an understanding of how computer networks allows for the transfer of data a brief discussion about such networks is provided. Computers and computer networks are used to exchange information in many fields such as media, commerce, and telecommunications, for example. The exchange of information between computers typically occurs between a “server application” that provides information or services, and a “client application” or device that receives the provided information and services. Multiple server applications are sometimes available on a “system server” such as a single computer server that provides services for multiple clients. Alternatively, distributed server systems allow a single client to obtain services from applications residing on multiple servers. For example, in current distributed server systems, client applications are able to communicate with server applications executing on the same computer system or on another computer system accessible via a network, for instance via the Internet.

The Internet is a worldwide network of interconnected computers. An Internet client computer accesses a computer on the network via an Internet provider. An Internet provider is an organization that provides a client (computer) with access to the Internet (via analog telephone line or Integrated Services Digital Network line, for example). A client can, for example, read information from, download a file from, or send an electronic mail message to another computer/client using the Internet.

To retrieve a file or service on the Internet, a client must typically search for the file or service, make a connection to the computer on which the file or service is stored, and download the file or access the service. Each of these steps may involve a separate application and access to multiple, dissimilar computer systems (e.g. Computer systems having operating different systems). The World Wide Web (WWW) was developed to provide a simpler, more uniform means for accessing information on the Internet.

The components of the WWW include browser software, network links, servers, and WWW protocols. The browser software, or browser, is a tool for displaying a user-friendly interface (i.e., front-end) that simplifies user access to content (information and services) on the WWW. Browsers use standard WWW protocols to access content on remote computers running WWW server processes. A browser allows a user to communicate a request to a WWW server without having to use the more obscure addressing scheme of the underlying Internet. A browser typically provides a graphical user interface (GUI) for displaying information and receiving input. Examples of browsers currently available include Netscape Navigator and Communicator, and Microsoft Internet Explorer.

WWW browsers and servers communicate over network links using standardized messages formats called protocols. The most common modern protocol is the TCP/IP (Transmission Control Protocol/Internet Protocol) protocol suite. The protocols are based on the OSI (Open Systems Interconnect) seven-layered network communication model. WWW messages are primarily encoded using Hypertext Transport Protocol (HTTP). HTTP instantiates the (top) Application layer of the OSI model. Application layer protocols facilitate remote access and resource sharing and are supported by the reliable communications ensured by the lower layers of the communications model. Therefore, HTTP simplifies remote access and resource sharing between clients and servers while providing reliable messaging on the WWW.

Information servers maintain the information on the WWW and are capable of processing client requests. HTTP has communication methods that allow clients to request data from a server and send information to the server.

To submit a request, the client browser contacts the HTTP server and transmits the request to the HTTP server. The request contains the communication method requested for the transaction (e.g., GET an object from the server or POST data to an object on the server). The HTTP server responds to the client by sending a status of the request and the requested information. The connection is then terminated between the client and the HTTP server.

A client request, therefore, consists of establishing a connection between the client and the HTTP server, performing the request, and terminating the connection. The HTTP server typically does not retain any information about the request after the connection has been terminated. That is, a client can make several requests of an HTTP server, but each individual request is treated independent of any other request.

The WWW employs an addressing scheme is that uniquely identifies Internet resources (e.g., HTTP server, file, or program) to clients and servers. This addressing scheme is called the Uniform Resource Locator (URL). A URL represents the Internet address of a resource on the WW. The URL contains information about the protocol, Internet domain name and addressing port of the site on which the server is running. It also identifies the location of the resource in the file structure of the server.

HTTP provides a mechanism of associating a URL address with active text. A browser generally displays active text as underlined and color-coded. When activated (by a mouse click, for example) the active text causes the browser to send a client request for a resource to the server indicated in the text's associated URL address. This mechanism is called a hyperlink. Hyperlinks provides the ability to create links within a document to move directly to other information. A hyperlink can request information stored on the current server or information from a remote server.

If the client requests a file, the HTTP server locates the file and sends it to the client. An HTTP server also has the ability to delegate work to gateway programs. The Common Gateway Interface (CGI) specification defines a mechanism by which HTTP servers communicate with gateway programs. A gateway program is referenced using a URL. The HTTP server activates the program specified in the URL and uses CGI mechanisms to pass program data sent by the client to the gateway program. Data is passed from the server to the gateway program via command-line arguments, standard input, or environment variables. The gateway program processes the data and returns its response to the server using CGI (via standard output, for example). The server forwards the data to the client using the HTTP.

When a browser displays information to a user it is typically as pages or documents (referred to as “web pages”). The document encoding language used to define the format for display of a Web page is called Hypertext Markup Language (HTML). A sever sends a Web page to a client in HTML format. The browser program interprets the HTML and displays the Web page in a format based on the control tag information in the HTML.

Current network systems provide a way to transfer and display data. However, these network systems have left the delivery of value-bearing instruments to traditional mechanisms such as mail, will call, and kiosks. The prior art therefore lacks a network system that provides a way to securely deliver, exchange, forward, and/or manage value-bearing instruments.

### BRIEF DESCRIPTION OF THE DRAWINGS

FIG. 1 illustrates the process utilized by one embodiment of the invention to generate a ticket and provide a ticket to a user.

FIG. 2 generally illustrates the elements of the system as utilized by one embodiment of the invention.

FIG. 3 shows one possible structure of a database utilized by one embodiment of the invention.

FIG. 4a illustrates an example implementation of one embodiment of the invention.

FIG. 4b illustrates the elements of a ticket as generated by one embodiment of the invention.

FIG. 4c illustrates a variation on the example implementation of FIG. 4a of one embodiment of the invention.

FIG. 5 shows the how the elements utilized in one embodiment of the invention interconnect.

FIG. 6 illustrates the process utilized by one embodiment of the invention to securely generate and print a ticket via a network connection.

FIG. 7 illustrates the elements utilized by one embodiment of the invention to securely generate and print a ticket via a network connection.

FIG. 8 illustrates how an embodiment of the invention can be implemented as computer software in the form of computer readable program code executed on one ore more general-purpose computers.

FIG. 9A shows the sequence of events associated with an initial ticket reissue as performed in one embodiment of the invention.

FIG. 9B illustrates the process utilized by one embodiment of the invention to securely add funds to a user account.

FIG. 10A illustrates how one embodiment of the invention enables the user to obtain a refund for a ticket.

FIG. 10B illustrates the remote verification process for one embodiment of the invention.

FIG. 11 is a flow diagram that shows how one embodiment of the invention provides a mechanism for forwarding a ticket to another party across a communication network.

FIG. 12 is a flow diagram that shows how one embodiment of the invention provides a mechanism for forwarding a ticket to another party across a communication network after the ticket is acquired.

FIG. 13 illustrates how to one user can obtain a ticket acquired by another user.

### SUMMARY OF THE INVENTION

One embodiment of the present invention comprises a method and apparatus for processing a value-bearing instrument. The system provides transaction services that let users and vendors securely exchange funds and value-bearing instruments.

The present invention provides users the conveniences of electronic transactions, and provides the security of authenticated exchange of funds for goods or services. Users of the invention may, among other options, electronically maintain funds on account, exchange purchases with a vendor or other party, auction purchases on the secondary market, restore a lost or destroyed item, create a transaction to be claimed in the future, or forward a purchase to another party.

The present invention provides vendors the ability to authenticate transactions the user has made with the invention. If the user generates a value-bearing instrument created with the invention, the vendor is able to interact with the invention to ensure that the generated instrument is authentic. Vendors may use the invention to, among other options, advertise additional goods and services, void transactions, give refunds, create a series of transactions with the user, or offer returned goods or services for resale.

The invention comprises a number of elements that could be physically distributed and connected through a network such as the public Internet or Virtual Private Networks. This invention does not define any requirements on the physical form of these connections except to require certain security requirements on the connections as described later in the invention. While certain interactions between these system elements are illustrated, this invention does not preclude other interactions between system elements.

### DETAILED DESCRIPTION OF THE INVENTION

The present invention is a method and apparatus for processing a value-bearing instrument. In the following description, numerous specific details are set forth to provide a more thorough description of the present invention. It will be apparent, however, to one skilled in the art, that the present invention may be practiced without these specific details. In other instances, well known features have not been described in detail so as not to obscure the present invention. Hereinafter, the term “system” is used to refer to a device and/or a method for performing a function that embodies the invention.

Hereinafter, the term Internet and/or network refers to any type of interconnection fabric that provides computers with a mechanism for transmitting and/or receiving data (e.g., intranets, local area networks, wide area networks, wireless networks, distributed server systems, or client/server architectures).

In one or more embodiments of the invention, an interconnection fabric comprises any of multiple suitable communication paths for carrying data between multiple computational devices. The interconnect fabric may be, for example, a local area network implemented as an Ethernet network, a virtual private network, or any other type of interconnect cable of sending data from one device to another. The interconnect fabric may be implemented with a physical medium such as a wire or fiber optic cable, or it may be implemented in a wireless environment.

In this document, the term ticket is utilized as an example of a value-bearing instrument. The invention, however, contemplates the use of any type of value-bearing instrument that may be redeemed for something of value. Value-bearing instruments comprise, for example, tickets, coupons, gift certificates, money orders, traveler's checks, and other forms of digital content having an intrinsic value. In one embodiment of the invention, value-bearing instruments may contain embedded data such as a document, music, videos, advertisements, and/or other types of digital information.

General Overview:

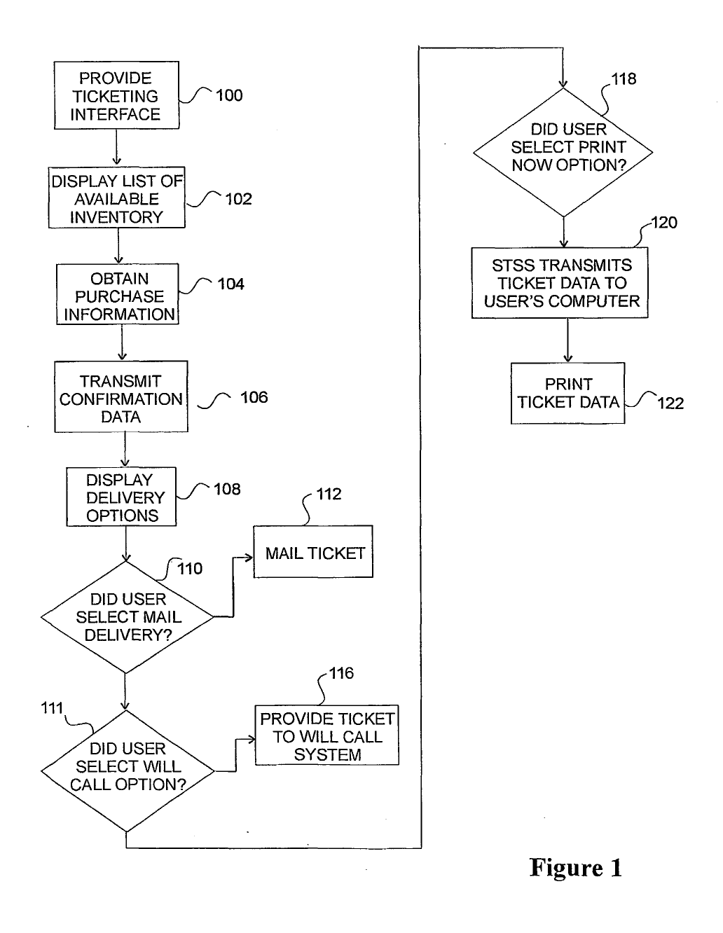

FIG. 1 illustrates the process utilized by one embodiment of the invention to generate a ticket and provide a ticket to a user. The process initiates at step 100 where the user visits a ticketing interface that contains an interface for selecting and purchasing an event ticket. The user may access the ticket interface via a web browser, a kiosk, or any other mechanism that can display an appropriate interface to a user. In this embodiment, information associated with the ticket is stored on the ticket as indicium. However, other embodiments of the invention may use other methods of storing or recording such information. Hereinafter, the term “secure content” will be used to describe a manifestation of a binary string which represents secure data associated with a value-bearing instrument.

In one embodiment of the invention, the user's web browser is switched to a secure web page hosted by a Ticketing Services System (TSS). The TSS provides a secure data tunnel between the TSS and the user's system via a network.

In one embodiment of the invention, a Secure Transaction Service System (STSS) provides security between the STSS, the Ticket Services System, and the user system. In one embodiment of the invention, the STSS can secure communications between the STSS and the Ticketing Services System by using a secure connection (e.g., 128 bit SSL). Connections between the STSS and the user system are also secure, but may utilize varying forms and/or strengths of security (e.g., differing levels of encryption). Information stored in the STSS is also electronically secure. The hardware and software systems that comprise the STSS are physically protected in a vaulted facility. The STSS maintains a digital certificate for each user that is protected by that user's unique id, password, and shared secret. STSS supports the ability to associate the user with specific client hardware, and security rules related to the user's client hardware can be enforced. Before a user is permitted to access the ticketing interface, the user typically registers with the system (e.g., the first time the user wishes to purchase a ticket). During registration, the user determines the user id, password, and shared secret stored in the STSS. Each subsequent use of the system requires input of the user's id and password. The system will check to see if the version presented by the user matches the version stored in the STSS. In one embodiment of the invention, the STSS validates the user's client hardware during the registration process and maintains a record of the hardware associated with a particular user.

In one embodiment, other information associated with the user, for example, the user's name, address, credit card or other identifying information is stored in a secure database as a user record. Each user record is associated with a unique digital certificate assigned to the user. The digital certificate is used to create a unique digital signature for each transaction and its associated value-bearing instrument, and therefore allows the ability to trace back each transaction to a certain user. The invention records the unique digital signature generated from each user's unique digital certificate along with other ticket content and/or demographic information on the ticket in the form of a manifestation of a secure binary string of data that is representative of value bearing instrument, such as a two dimensional indicium.

Once the registration process is complete, and the user has an account on the system, the user may log in to the Ticketing Services System. The secure data tunnels and other connections associated with the user's request for the ticket interface are established by the TSS during step 100. At step 102, the TSS presents a list of available tickets to the user. The list may be customized to present certain types of lists and may contain graphical representations of each item in the list. For example, the TSS may present the user with a list of events that will occur during the month of Mar.. The invention contemplates generating lists based on preferences specified by the user and/or preferences derived from data about the user. Once the user peruses through the list and selects a ticket for purchase, step 104 executes.

At step 104, the TSS obtains purchase information from the user and determines whether the information presented is valid. If for example, the user presents a credit card, the system verifies the credit card information and obtains an approval code. The system verifies the purchase information, then transmits confirmation data to the user (e.g., step 106) and displays a list of delivery options (e.g., step 108). In accordance with one embodiment of the invention the delivery options the system presents comprises a mail option, a reserve option, and a generate-now option. The invention also contemplates other options such as delivery to an electronic device (e.g., a cell phone or PDA).

The user may select a delivery preference and the system will provide the selected item (e.g., the ticket) via the preferred method. The ticketing service system, through a secure data connection, passes the ticket content to the STSS. A physical and digital version of the ticket is generated by the STSS. In one embodiment of the invention, the ticket comprises secure content that contains a digital signature and/or any other information requested or required by the ticket service system. The secure ticket content comprises information that relates to the transaction being performed. For example, the ticket may contain a seating assignment, an event date, a customer name, and/or any other type of information the ticket producer wishes to include. An embodiment of the invention contemplates sale and/or use of available space on the ticket. For example, the providing entity may incorporate advertisements, coupons, and maps on the ticket or on any other type of value-bearing instrument. The ticket may also comprise information associated with the utilization of pre-paid services and/or information related to the acquisition of products, merchandise, and/or services. In some instances, the ticket comprises a product itself (e.g., if the ticket/value-bearing instrument is a form of currency, a secured instrument, or a stock certificate). The ticketing service system is designed to specify to the STSS which data elements will appear on the ticket as human readable text and which data elements are represented as machine readable secure content.

The user selects, via the TSS, a delivery method after generating a ticket. At step 110, for example, the system determines if the user elected to have the ticket delivered via mail. If so, step 112 executes and the ticket is delivered via mail. The term mail comprises an electronic mail and/or delivery via a postal system such as the U.S. Postal System. If the user did not pick delivery via mail, step 114 executes and the system determines if the user selected the reserve option. If the user selected the reserve option, the system executes step 116, where it provides the ticket and/or the ticket data to a reservation system. The intended recipient of the ticket may acquire the ticket by obtaining it from the reservation system. In one embodiment of the invention, the ticket is delivered to the reservation system electronically and may be obtained from the system when the intended recipient requests delivery of it. If the user did not select the reserve option, the STSS determines whether the user selected the generate-now option (e.g., step 118). In one embodiment of the invention, the generate-now option provides the user with a mechanism for generating the selected item (e.g., printing a ticket directly to the user's personal printer.) If the generate-now command is not selected, the TSS continues to display the list of delivery options, until the user chooses one. If the user does not select a delivery option, but instead exits the program, the STSS may use a default delivery option. If, however, the user does select the generate-now option then steps 120 and 122 execute. At step 120, the STSS transmits the ticket data to the user's computer via a network. Once the ticket data resides on the user's computer, it is output to a printer. The invention may also transmit a value-bearing instrument to other types of devices, such as a PDA or cell phone.

System Elements:

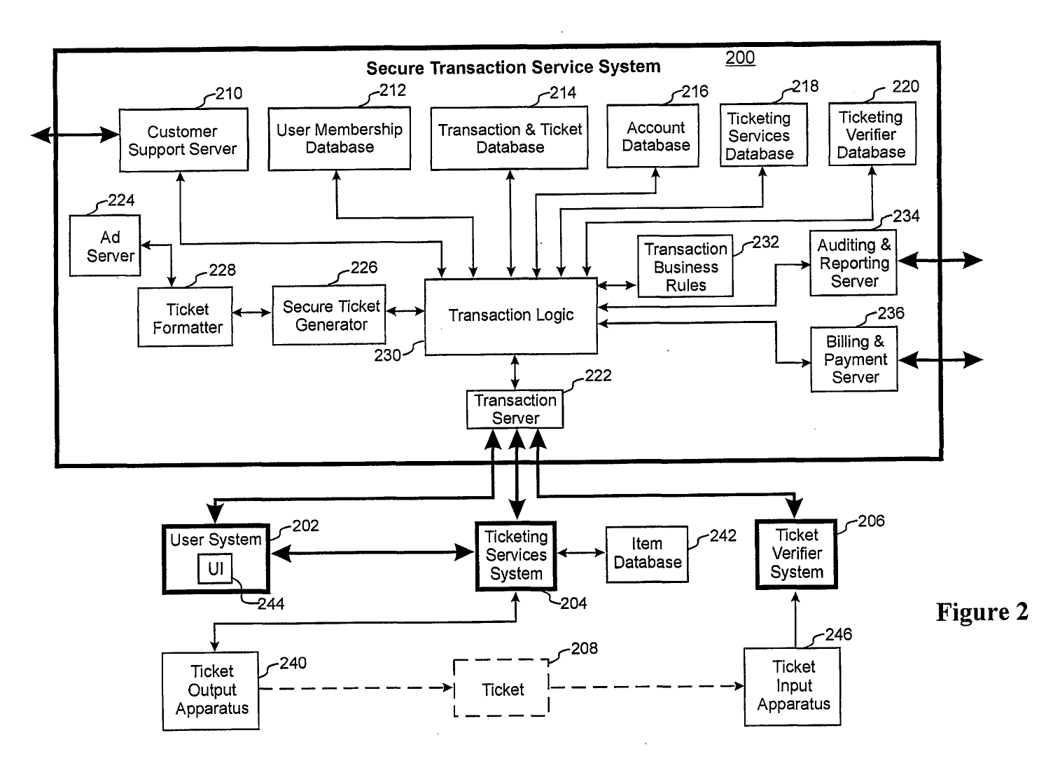

FIG. 2 illustrates generally the elements of the system (shown as boxes with thick borders) as utilized by one embodiment of the invention. The system comprises STSS 200, user system 202, ticketing services system 204, and ticket verifier system 206. Functional elements associated with the system elements are shown as boxes with thin lines. The connections between the system elements (shown as thick arrows) show possible logical connections between the system elements although in some instances other logical connections may exist. The system elements are assumed secure, and communication between the system elements is achieved through a secure communications channel that mutually authenticates the parties (e.g., SSL or some other secure protocol suite). These system elements may be physically distributed and connected through a network such as the public Internet, a virtual private network, or any other interconnection fabric configured to allow computers to send and receive data. This invention does not define any requirements on the physical form of these connections except to require certain security requirements on the connections as described later in the invention. While certain interactions between these system elements are illustrated, this invention does not preclude other interactions between system elements.

Each system element is configured to perform certain functions. The functions performed by one embodiment of the invention are discussed in further detail below. STSS 200 is configured to issue and distribute one or more tickets 208. Each ticket 208 comprises a machine-readable portion and a human readable portion. The machine-readable portion allows ticket 208 to be uniquely identified. STSS 200 is also responsible for securely maintaining transaction records for transactions performed on the ticket. STSS comprises a transaction server 222 and numerous databases configured to support the system. STSS 200 may contain, for example, a user membership database 212, a transaction and ticket database 214, an account database 216, a ticketing services database 218, and a ticket verifier database 220. A secure ticket generator 226, a ticket formatter 228, and an ad server 224 may also be integrated into STSS 200. In an embodiment of the invention, transaction server 222 interfaces with transaction logic module 230. Transaction logic module 230 is configured to obtain business rules from business rules module 232. STSS 200 also comprises auditing and reporting server 234 as well as billing and payment processing server 236.

In one embodiment of the invention, transaction server 222 provides the external interface with user system 202, ticketing services system 204, and ticket verifier system 206 so that each of these systems can request various ticketing transactions. The communication channel between transaction server 222 and these other system elements is assumed to be secure and mutually authenticated. Transaction server 222 is configured to dispatch transaction requests (e.g., a request for a ticket) to transaction logic module 230.

Transaction logic module 230 is configured to carry out the transactions associated with obtaining, generating, and/or verifying tickets. Transaction logic module 230 ensures that the transactions performed on the ticket are carried out to completion and that the appropriate databases are updated. As such, transaction logic module 230 coordinates the activities of other components that participate in execution of the transaction. In one embodiment of the invention, transaction logic module 230 is independent of a particular ticketing application. For example, transaction logic module 230 typically obtains application-specific instructions from business rules module 232.

Business rules module 232 enables the system to support a wide variety of ticketing applications. For example, event ticketing, coupon generation, or airline ticketing can all be considered different ticketing applications. As such, these different ticketing applications may require different actions to be taken by the system for a particular transaction. When a transaction is being processed by transaction logic module 230, business rules module 232 may, for example, determine the application associated with the transaction and provide instructions to perform various application-specific actions that are to be performed by transaction logic module 230. Business rules module 232 is a logical extension to transaction logic module 230. While transaction logic module 230 is generic and independent of specific ticketing application, business rules module 232 is capable of translating application specific semantics into generic form that transaction logic module 230 understands. Business rules module 232 is capable of storing the logic associated with many different types of business transactions. Each set of logic has a unique identifier that can be used to specify the particular business rules to apply to the transaction being processed. The application specific business rules are input into business rules module 232 using a language capable of expressing the semantics of the business rules. Business rules module 232 can potentially support several such semantic languages.

Secure ticket generator 226 is configured to generate a ticket formatted for a specified ticket output apparatus. The ticket comprises secure content that can uniquely identify the ticket. Secure ticket generator 226 passes the ticket to ticket formatter 228, which in turn generates the formatted ticket for the ticket output apparatus (e.g., a printer).

Ticket formatter 228 component enables the system to control the placement of different content on the physical form of the ticket. For example, in one embodiment of this invention, a printed ticket comprises secure content, ticket information, advertisements, secure content for merchandise at a venue, and directions to the venue. Ticket formatter 228 is capable of storing many different formatting rules. Each has a unique identifier that can be used to specify the particular formatting rules to apply for a given ticket. The format rules and constraints are input into ticket formatter 228 using a language capable of expressing the semantics of the formatting rules. Ticket formatter 228 can potentially support several such semantic languages.

Ad server 224 interacts with ticket formatter 228 to provide advertisement content for the ticket. Ad server 224 can provide different ad content depending on the user or the particular venue that the ticket is intended for. The ad content rules and constrains are input into ticket formatter 228 using a language capable of expressing the semantics for ad selection. Ad server 224 can potentially support several such semantic languages.

Transaction and ticket database 214 is a secure database that keeps track of issued tickets and the state of the ticket. It also keeps track of all transactions performed on the ticket. There are several logical records in the database.

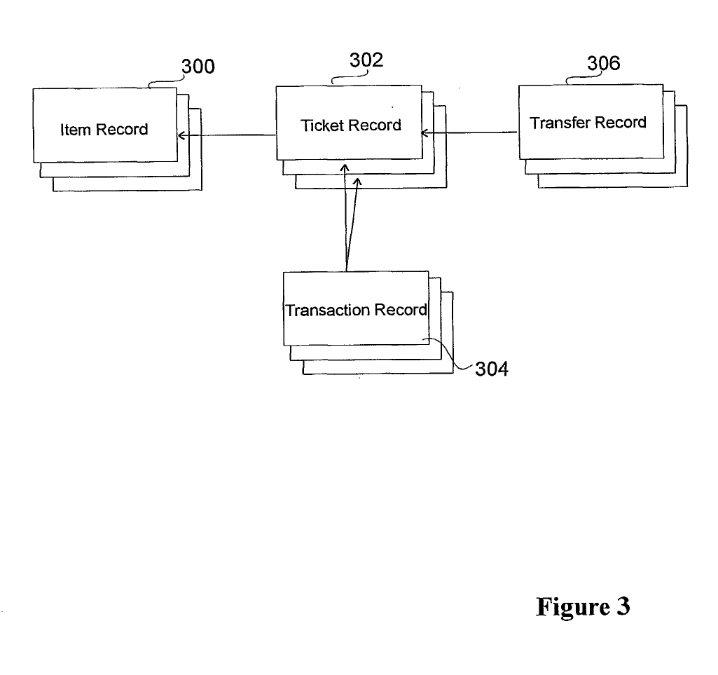

FIG. 3 shows one possible structure of the database. However, the invention contemplates the user of other types of relational structures. Item record 300, in one embodiment of the invention, resides in transaction database 214 and represents each unique good and service tracked by STSS 200. Each item record 300 may, for example, comprise the following information:

Item ID: A unique identification of the item (i.e., goods or services) generated by STSS 200.

Account: The account that is the current owner of the item.

Item State: The state of the item.

Item Group: Data provided by the TSS 204 to group like-items. Can be used to alter a group of records.

Item Data: Other data provided by the TSS 204 about the item.

Start Date: The date from which the invention assumes the item is valid.

Expiration date: The date on which the item and the associated ticket must be automatically deleted by the system.

Purge date: The date which the item and the associated ticket can be purged from transaction database 214.

STSS 200 creates ticket record 302 for each ticket it issues. Each ticket record 302 may, for example, comprise the following information:

Ticket ID: A unique identification of the ticket.

Item ID: Indicates what the ticket is for.

Account: The account that is associated with the ticket.

Ticket State: The state of the issued ticket.

TSS Ticket Content: The content of the ticket that Ticketing Service System 204 provided.

TSS Transaction Information: The content of the transaction provided by Ticketing Service System 204.

Ticket Output Format: The output format of the ticket.

Transaction Record 304 is created for each transaction issued by user system 202 or ticketing services system 206. Transaction record 304 may therefore be used for auditing, billing purposes as well as for recovery purposes. Each transaction record 304 may, for example, comprise the following:

Transaction ID: A unique identification of the transaction.

Transaction Type: The type of the transaction that was requested

Transaction State: The state of the transaction e.g., pending, completed

Target Ticket: Ticket ID for which the transaction is intended.

Source Ticket: Ticket ID for the source ticket if multiple tickets are involved in the transaction.

Transfer Authorization Record 306 is created by one embodiment of the invention whenever a ticket is in the process of being transferred. Transfer authorization 306 may, for example, comprise:

Transfer Authorization: Information used to authorize the ticket transfer.

Transfer Authorization Method: Indicates the particular method of authorization for transferring the ticket.

Account: The account that is associated with the transaction.

Ticket ID: The ID of the original ticket.

Transfer State: The state of the transfer authorization code: pending, transferred

Accounting database 216 comprises a secure database configured to keep track of funds on behalf of the users for the purchase/refund of tickets, services, and merchandise. A user can be associated with several accounts with funds. The database also contains user-specific authentication data that enables the system to sign ticket content on behalf of the user. A unique digital certificate is generated for the user at the time of membership registration and stored into accounting database 216.

User membership database 212 keeps track of the users that have registered with the system. User membership database 212 typically contains general information about the user. Fields include, for example: unique user ID, user name, password, shared secret, email address, last user system (i.e., the id of the user system that was used last), and any other fields the entity generating the database wished to collect.

Ticketing services database 218 is configured to keep track of registered ticketing services. The database stores general information as well as authentication data to enable authenticated and secure communication between STSS and the ticketing services system 204. The fields of the database comprise, for example, the unique id of TSS 204, TSS 204 authentication data, email address of TSS 204, postal mailing address of TSS 204, and any other fields the entity generating the database wished to collect.

Ticket verifier database 220 keeps track of registered ticket verifier systems 206 by storing general information about each ticket verifier as well as authentication data to enable authenticated and secure communication between STSS 200 and ticket verifier system 206. The fields of the database may comprise, for example, the unique id of the verifier, verifier authentication data, email of the venue (if applicable), venue address, and any other fields the entity generating the database wished to collect.

Auditing and reporting server 234 enables external systems to generate auditing and other general reports about transactions that occur on the system. The client computer that communicates with the auditing and reporting server 234 of the server is, in one embodiment of the invention, an authenticated system. This precaution is intended to prevent unauthorized access to the data.

Billing and payment server 236 interfaces with the external billing and payment services to enable financial transactions to take place (e.g. credit card companies and/or banks). The client that communicates with the billing and payment server may be an authenticated system.

Customer support server 210 interfaces with the internal customer support systems to enable access to data and modification thereof on behalf of customers. The client that communicates with customer support server 210 may also be an authenticated system.

Ticketing services system 204 is an agent of the vendor who provides items of value that can be redeemed using a valid ticket. In one embodiment of the invention, ticketing services system 204 is capable of controlling ticket output apparatus 240. This is the case where ticketing services system 204 itself prints and distributes “secure” tickets with unique secure content added to the standard printed output. However, other systems (e.g., user system 202) may also transmit output to ticket output apparatus 240. Item database 242 optionally keeps track of goods, services and other items of value that the ticket can be redeemed for. Ticketing service system 204 typically maintains the database.

User system 202 provides user interface 244 that enables the user to perform various transactions associated with tickets such as issuing ticket 208. As such, it provides a mechanism for communicating with other system elements in carrying out the requested transactions. It also is capable of controlling ticket output apparatus 240 in the case where a physical form of the ticket needs to be generated (e.g. by printing ticket 208). User system 202 can be a PC with a Web browser and a printer. User system 202 can also be a mobile phone, personal digital assistant, smart card, or any other computer system configured to interface with STSS 200.

Ticket verifier system 206 typically resides at the location where the ticket is redeemed for goods and services. It has the capability to read the ticket information and, in some embodiments, to contact the STSS 200 to verify the validity of ticket 208. Ticket verifier system 206 is also capable of receiving the results of the ticket verification from transaction server 222, and take appropriate action based on the returned results.

The action taken by ticket verifier system 206 after receiving the results is application dependent. For example, ticket verifier system 206 may provide a user interface to the operator to display appropriate message to the operator. The component may also provide the interface to devices such as a gate or turnstile to control entry into a venue.

Ticket output apparatus 240 creates the physical form of the ticket. For example, a printer is a ticket output apparatus 240 for printing ticket, and/or any other value-bearing instrument, from a computer such as a PC. A smart card programming device could also be a ticket output apparatus 240.

Ticket input apparatus 246 reads the physical form of the ticket. For example, a scanner may act as ticket input apparatus 246 for printed tickets. A smart card reader may also be configured to acts as ticket input apparatus 246.

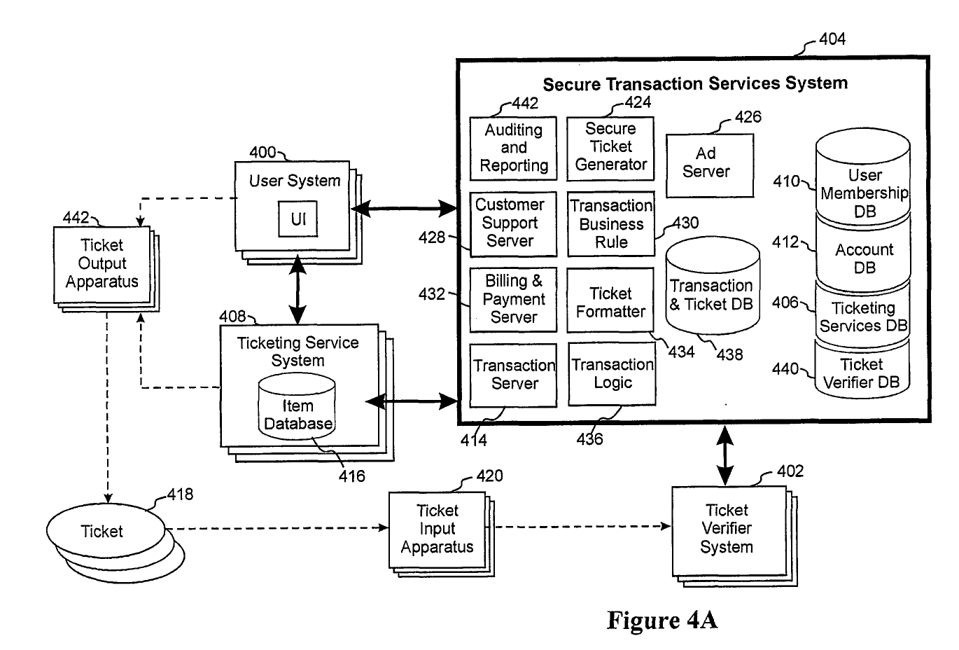

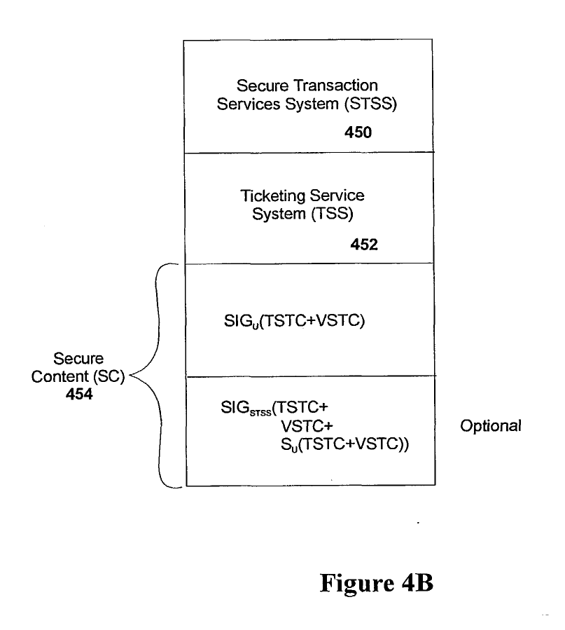

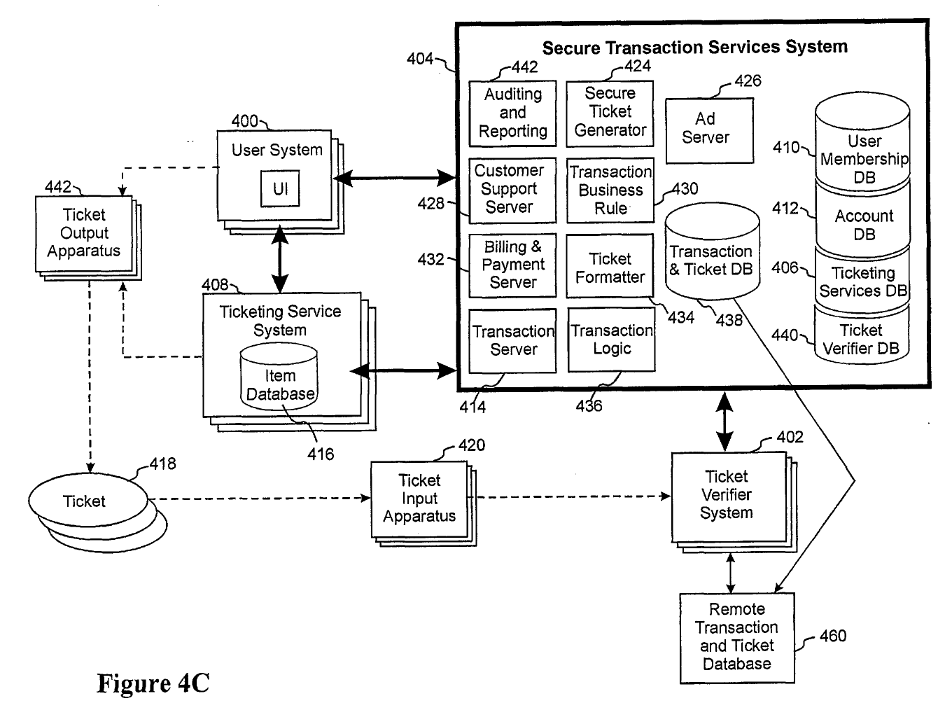

FIG. 4A illustrates an example implementation of one embodiment of the invention. In this example, the system comprises multiple user systems 400, ticketing services system 408 and ticket verifier system 402. Each system is configured to interact with one another. In one embodiment of the invention, user system 400 may be a browser that is connected with the ticketing services system 408 and STSS 404. When user system 400 comprises a browser, STSS 404 may download a plugin into user system 400 in order to provide additional security beyond what is available through the browser. This plugin can establish a secure connection to STSS 404.

User system 400 interacts with ticketing services system 408 to reserve or purchase something of value through a computer network such as the Internet. User system 400 then communicates with STSS 404 to obtain ticket 418 and may use ticket output apparatus 442 to reduce ticket 418 to a tangible form. At the location where ticket 418 is redeemed, ticket input apparatus 420 reads the ticket. Ticket verifier system 402 communicates with STSS 404 to verify ticket 418.

STSS 404 comprises a plurality of elements each configured to add functionality to the system. For example, STSS 404 may comprise the following elements: auditing and reporting element 422, secure ticket generator 424, ad server 426, customer support server 428, business rule module 430, billing and payment server 432, ticket formatter 434, transaction server 414, transaction logic module 436, transaction and ticket database 438, user membership database 410, account database 412, ticketing services database 406, and ticket verifier database 440.

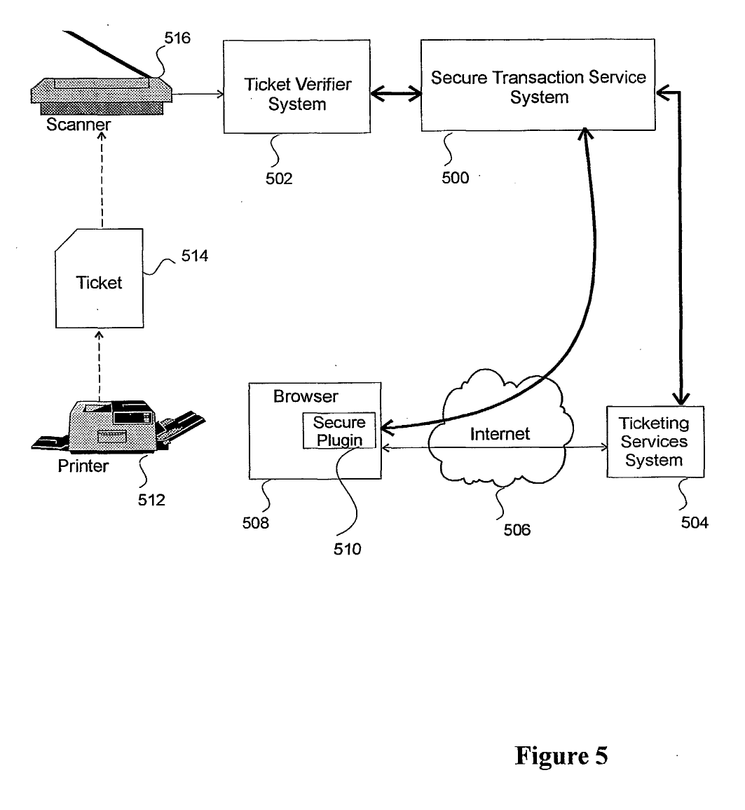

FIG. 5 shows how one embodiment of the invention interconnects. For example, in this embodiment STSS 500, ticket verifier system 502, and ticketing services system 504 do not connect to one another through Internet 506. This invention, however, does not preclude utilizing the Internet to make such connection as long as transactions sent across such a network are secured. Browser 508, using secure plugin 510, however typically interfaces with ticketing services system 504 via Internet 506. Once a ticket is generated it may be printed via printer 512. Thus, ticket 514 is a tangible representation of the ticket created by interfacing with ticketing services system 504. Ticket 514 may be verified by scanning the ticket with scanner 516. Scanner 516 communicates with ticket verifier system 502 to determine if the ticket is authentic (e.g., by verifying the digital signature associated with the ticket).

Data Objects

One embodiment of the invention comprises one or more data objects. Hereinafter the term “token” is used in its broadest sense, to indicate an element of data that may be comprised of one or more sub-elements.

TSS confirmation token (TCT) is an object that uniquely identifies the goods or services that the user has reserved or purchased. The TSS confirmation token and detailed information about the transaction may be stored into the ticketing services database 406. The token can be a simple number, or some other digital form of information.

TSS ticket content (TTC) 452 (see e.g., FIG. 4B) is an object comprising ticketing services system 408 specific information that will be recorded on a ticket. Ticketing services system 408 and ticket verifier system 402 can interpret the content and act on the information. TSS ticket content objects fit into the ticket.

TSS transaction information (TTI) is an object comprising the data supplied by ticketing services system 408 that are be interpreted by and acted upon STSS 404. The data comprises:

Ticket Printable/Displayable Information: The specification as to what information is to be put into the output format of the ticket that can be visible to the user.

Verifier ID: One or more verifiers that can verify the ticket.

Item Data: Data to store into the Item Record. For example, Start Date, Expiration Date, Purge Date, Item Group.

Transaction system ticket content (TSTC) 450 object comprises content put into the ticket that is specific to STSS 404. The information may include, but is not limited to:

Secure Content version number

Digital Signature Algorithm

STSS ID: Uniquely identifies the transaction system that issued the ticket. It may be used in cases where there are multiple transaction systems on the network.

User ID: Identifies the user of the ticket.

TSS ID: ID of the TSS that supplied the ticket.

Item ID: The item to which the ticket is issued for.

Verifier ID: The verifier of the ticket

Ticket ID: The ticket record for this ticket

Ticket State: The state of the ticket.

Start Date

Expiration Date

Secure Content (SC) 454 object comprises the signed digital content of the secure content that is to be put into the ticket. Secure content may contain the following content:

TSTC+TTC+SIG_{U}(TSTC+TTC)|S_{STSS}(TSTC+TTC+SIG_{U}(TSTC+TTC)).

Where the + indicates concatenation operation and | indicates an optional concatenation operation. S_{Y}(X) represents the output of a digital signature function where message X is signed by entity Y. U refers to the user and STSS refers to STSS 404.

Secure content typically indicates which digital signature algorithm is used. Possible digital signature algorithms include, but are not limited to, the Digital Signature Standard (DSS) or the Elliptic Curve Digital Signature Algorithm. However, the invention contemplates the use of other methods for generating a digital signature.

Secure content for a ticket is typically formatted for a particular ticket output format. For example, for printed tickets, ticket secure content may take on the form of printable symbologies such as a 2-D barcode.

In one embodiment of the invention, the ticket is formatted to support the particular ticket output format that is to be used. The format typically comprises a ticket secure content and may include additional information requested by TSS 204. For example, TSS 204 may request that an advertisement be included in the printed form of the ticket.

Ticketing Transactions

The following subsections describe various transactions and services that one embodiment of the invention associates with ticketing. It will be apparent to one skilled in the art that the examples provided are not restricted to ticketing applications and may therefore be practiced on all types of value-bearing instruments, or any other form of digital content having an intrinsic value.

A. User Registration and Login

Each user establishes a trusted relationship with ticketing service system 408 and STSS 404 in order to participate in various ticketing transactions. In one embodiment of the invention, the user accomplishes this by registering with ticketing service system 408 and STSS 404.

User system 400, for example, may authenticate the user before it can participate in any transaction on behalf of the user. If the user has an account in user membership database 410, user system 400 provides the user's authentication data to STSS 404 in order to establish the identity of the user. The authentication data could be, for example, a user name and password.

If the user does not have an account, the user may register with STSS 404 to create one. The system will guide the user through the registration process. STSS 404, for example, may request user system 400 to provide registration info and unique authentication data. The authentication data may include a unique user name, password and shared secret. A unique digital certificate is generated for the user, and an account (i.e., an entry) is created in the account database 412. Following registration, the user logs in and proceeds with the transaction.

STSS 404 may elect to store the identification of the user system 400 that last accessed the user account in user membership database 410. If transaction server 414 detects that user system 400 is different from the one used last, the system will warn the user if the user account indicates that the user wants such a warning.

As part of the registration process, a software module may be downloaded into user system to facilitate future secure connection with STSS 404. For example, if user system 400 is a browser, a plugin may be downloaded into the browser.

B. Initial Instrument Generation (For Example Secure Printing Via a Network)

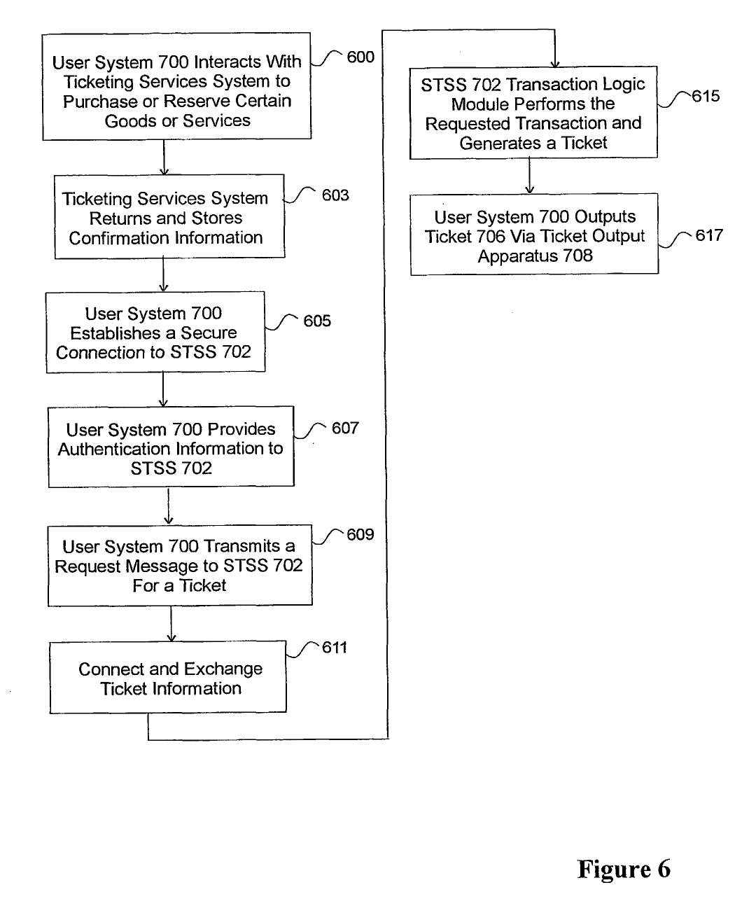

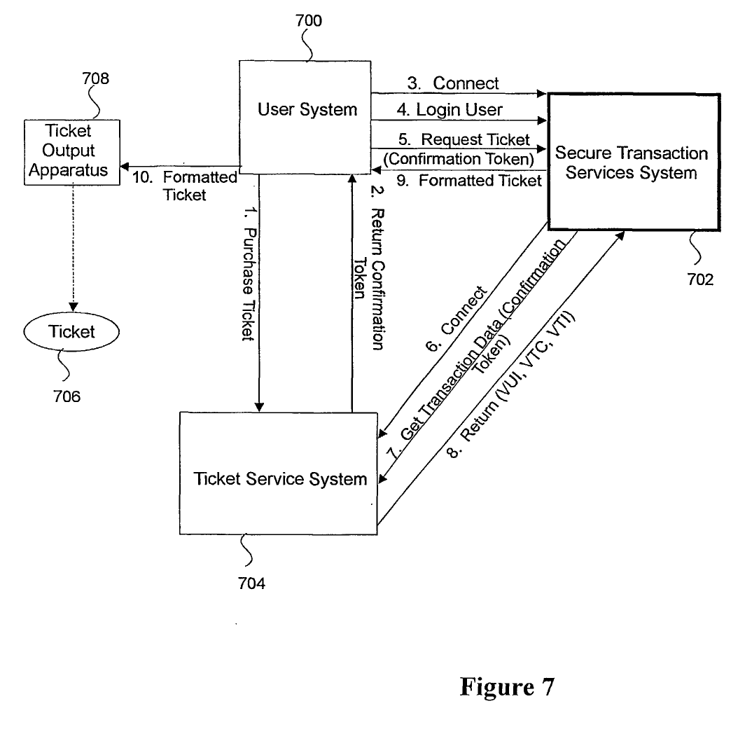

The invention, in one or more embodiments, provides the user a mechanism to generate an initial value-bearing instrument. FIG. 6 illustrates the process utilized by one embodiment of the invention, where for example the user uses the invention to securely generate and print a ticket via an interconnection fabric. The sequence of events associated with the initial ticket issuance begins at step 600 where user system 700, on behalf of the user, interacts with ticketing services system 704 to purchase or reserve certain goods or services. (See FIG. 7.) In response, step 603 executes and ticketing services system 704 returns a TSS confirmation token and TSS identification for the transaction that occurred between the user and ticketing services system 704. A TSS confirmation token uniquely identifies an item that the user has reserved or purchased. Typically, the item is stored in an item database associated with ticketing services system 704. This TSS confirmation token and detailed information about the transaction is stored into a ticketing services database 406. The token can be formatted as a simple number, or some other structured, digital form of information.

At step 605, user system 700 establishes a secure connection to the STSS, and the two systems are mutually authenticated. Once the systems are authenticated, step 607 executes and user system 700 provides the user authentication information to STSS 702. STSS 702 authenticates the user. The authentication information could be a user name and a password.

After the user is authenticated, step 609 executes and user system 700 transmits a request for a ticket to STSS 702. For example, user system 700 may send a message to STSS 702 requesting that a ticket be issued for the transaction that the user had with ticketing services system 704. The TSS confirmation token is typically provided with the message. The output format of the ticket the user wants may also be indicated. The output format, for example, can be a print-ready format appropriate for a printer. It could also be an output format appropriate for a smart card or personal digital appliance.

At step 611, STSS 702 and ticketing services system 704 connect and exchange ticket information. For example, STSS 702 may send a message to ticketing services system 704 requesting information about ticketing services system 704's transaction identified by the confirmation token. While the scenario described here assumes that the information is pulled from ticketing services system 704, ticketing services system 704 may be configured to push the information onto STSS 702. Continuing at step 611, ticketing services system 704 returns the requested information. The information may comprise, but is not limited to:

TSS Ticket Content (TTC): The content that is stored on the ticket. STSS does not interpret this data.

TSS Transaction Information (TTI): The information that is required by and interpreted by STSS 704.

At step 615, STSS 702's transaction logic module performs the requested transaction and generates a ticket. To generate a ticket, a ticket generator creates a unique secure content with the digital signature of the user and the digital signature of the STSS. Ticket secure content, appropriate for the specified ticket output format, is created. A ticket output format is created using a ticket formatter. The ticket output format is dependent on the ticket output format. A ticket output format may comprise visible data indicated by ticketing services system 704 to be included in the ticket. It could also include advertisement information. Once the ticket is generated the ticket is returned to user system 700 and the transaction and ticket database is updated appropriately. At step 617, user system 700 outputs ticket 706 using ticket output apparatus 708. Note that ticketing services system 704 can also output ticket 706 directly.

C. Value-Bearing Instrument Formatting (For Example, a Ticket Comprising Printed Coupons, Advertisements, and Maps)

Ticketing services system 204 communicates with STSS 200 to provide the formatting rules to ticket formatter 228. The format rules and constraints are input into ticket formatter 228 using a language that expresses the semantics of the formatting rules. Ticket formatter 228 can potentially support several such semantic languages. Ticket formatter 228 also may include a database that contains additional information (e.g., maps).

Ad server 224 is also populated with different advertisement information. Ticketing service and item (e.g., venue) specific rules and constraints that specify the advertisement content are supplied.

When a new ticket needs to be generated, transaction logic module 230 instructs secure ticket generator 226 to generate ticket 208. Secure ticket generator 226 in turn instructs ticket formatter 228 to format the ticket based on the information supplied to it. Ad server 224 interacts with ticket formatter 228 to provide advertisement content for ticket 208. In one embodiment of the invention, ad server 224 can provide different advertisement content depending on the user or the particular venue that the ticket is intended for. Ad server 224 may also provide data that relates to pre-paid services and/or products.

D. Re-Issuing a Value-Bearing Instrument (For Example, Reprinting a Ticket that was Lost or Destroyed)

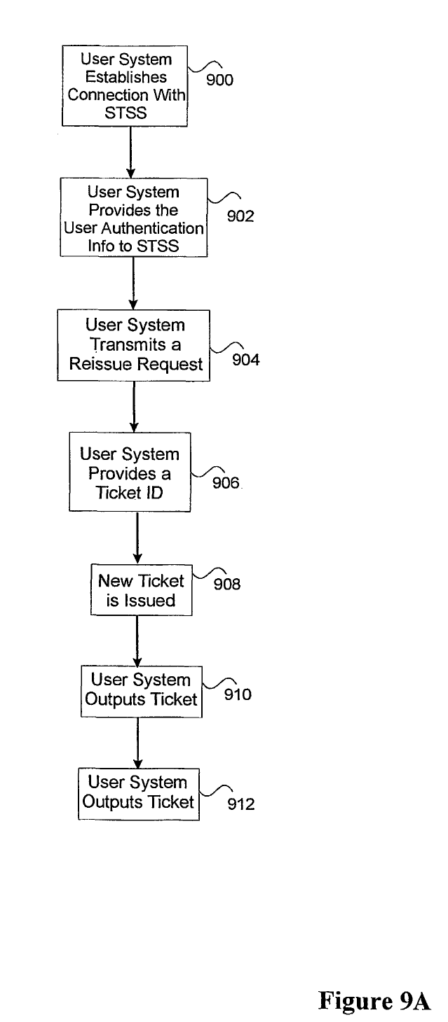

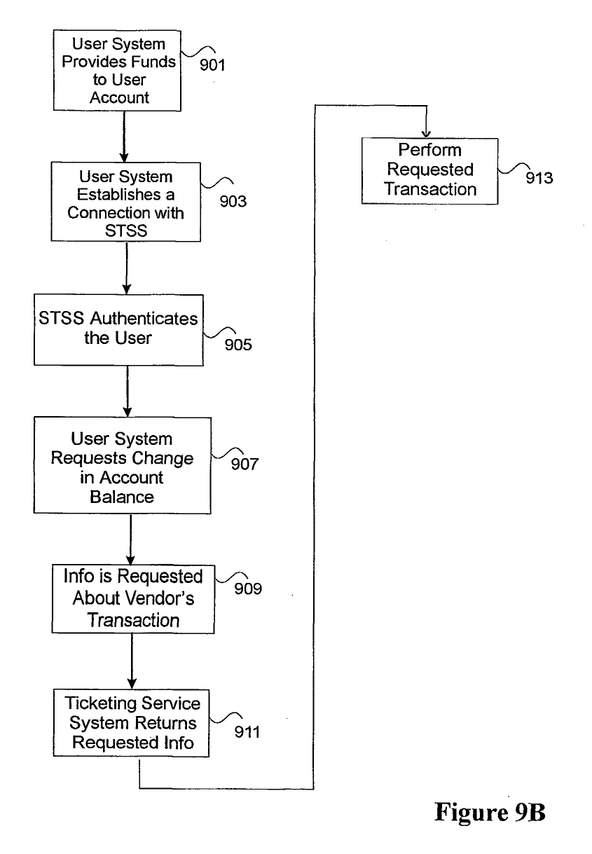

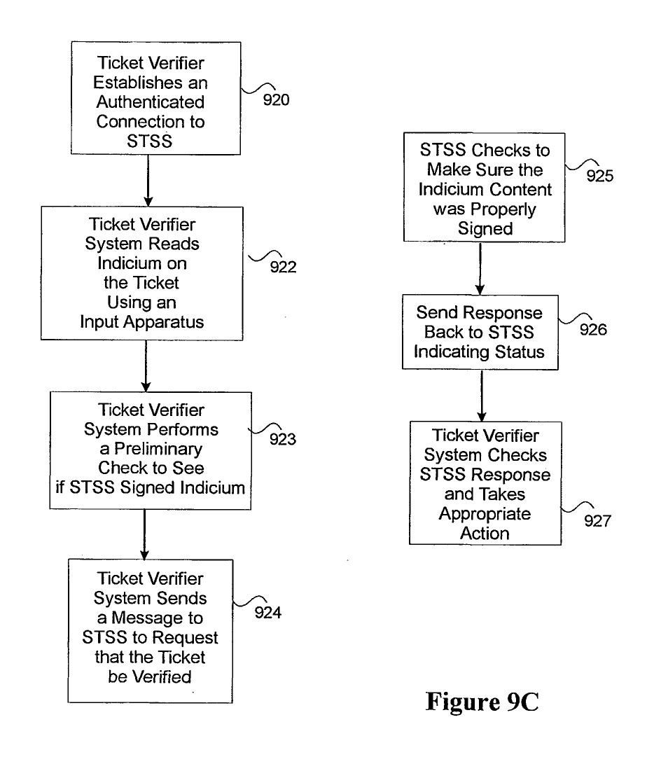

In one embodiment of the invention, a lost or destroyed value-bearing instrument may be reissued. The value-bearing instrument re-issuing process enables the user to obtain another copy of the original instrument. The user can optionally request that the format of the re-issued instrument be changed. In an embodiment which issues tickets, the user can, for example, change the format from printed ticket to a ticket stored on a smart card. The sequence of events associated with the example of an embodiment of the invention which reissues tickets is illustrated in FIG. 9A.

At step 900, user system 202 establishes a connection to STSS 200, and the two systems are mutually authenticated. User system 202 provides the user authentication information to STSS 200. STSS 200 authenticates the user (e.g., step 902). The authentication information could be, for example, a user name and a password. At step 904, user system 202 transmits a message to STSS 200 to request that a ticket be reissued. The message may request that the ticket be issued in the same format as the original or in a different format. Once step 904 executes, the invention proceeds to step 906 where STSS 200 sends a message requesting user system 202 to provide a unique identifier such as a ticket ID. The ticket ID identified the ticket that is to be re-issued. Once the unique identifier is provided step 908 executes. At step 908, STSS 200 issues the new ticket. In one embodiment of the invention ticket generator 226 creates a new unique secure content with the signature of the user and the signature of STSS 200. The secure content therefore uniquely identifies the transaction. In one embodiment of the invention, the subsequent secure content is not the same as the original secure content. Step 908 comprises creating a ticket secure content that is appropriate for the specified ticket output format. A ticket output format is also created using ticket formatter 228. The ticket output format is dependent on the ticket output format. A ticket output format may include visible data that ticketing services system 204 indicates should be included. It may also include advertisement information.

In step 908, ticketing services system 204 is contacted and informed of the transaction. The ticket is provided to user system 202 and transaction and ticket database 214 is updated appropriately. The status of the original ticket is flagged in transaction and ticket database 214. In one embodiment of the invention (e.g., at step 910), user system 202 outputs a re-issued ticket 208 using ticket output apparatus 240. At step 912 the system may invalidate the original ticket. Ticketing services system 204 can also output ticket 208 directly, via ticket output apparatus 240.

E. Exchange of a Value-Bearing Instrument (For Example, the Exchange of a Printed Ticket with the Originating Entity Over the Internet)

Utilizing the invention, a user has the ability to exchange one value-bearing instrument for another with the original content provider. In one embodiment of the invention, a printed ticket may be exchanged with the originating entity via a network connection such as the Internet. The exchange process involves a two step process involves returning the ticket and then issuing a new ticket if requested.

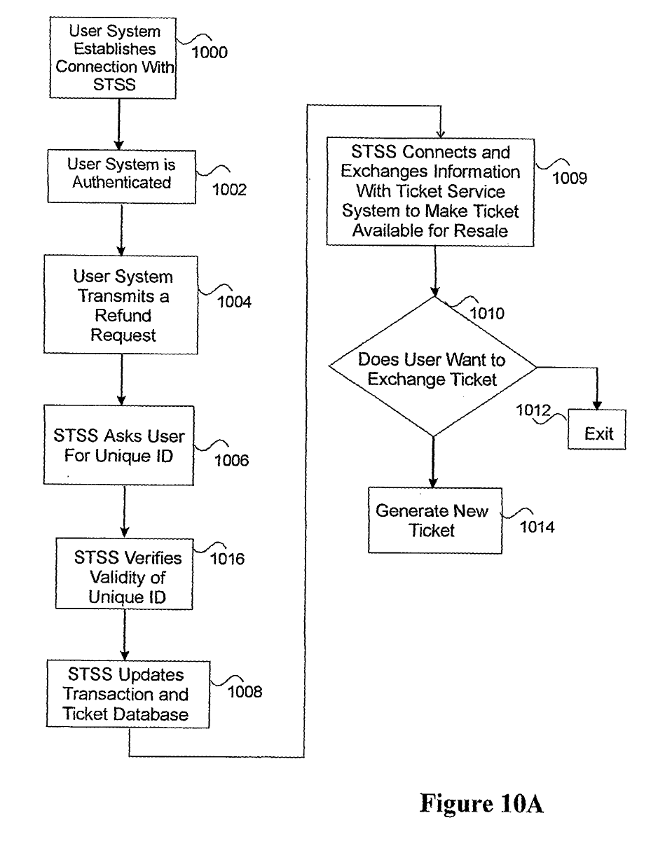

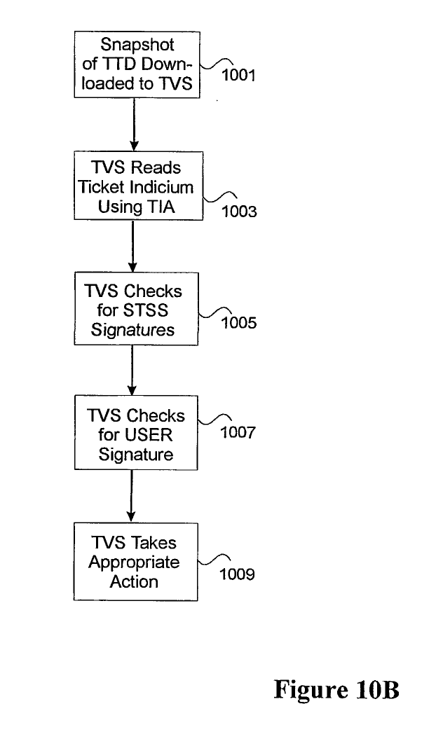

FIG. 10A illustrates how one embodiment of the invention enables the user to obtain a refund for a ticket. The sequence of events begins at step 1000 where user system 202 establishes a connection to STSS 200, and the two systems are mutually authenticated. At step 1002 user system 202 provides the user authentication information to STSS 200. STSS 200 authenticates the user. The authentication information could be a user name and a password. At step 1004 user system 202 sends a refund request to STSS 200. For example, user system send a message to STSS 200 to request that the cost of the ticket, minus some content provider specified transaction fee, be refunded to the user. STSS 200 verifies if the user is allowed to perform this transaction. At step 1006 STSS 200 sends a message requesting user system 202 to provide a unique identifier such as a ticket ID. At step 1007 STSS 200 verifies the validity of the unique id. Once the unique identifier is provided, step 1008 executes and thereby STSS 200 updates transaction and ticket database 438 to reflect the request. At step 1008 ticketing services system 204 is informed of the transaction, the appropriate financial transactions are carried out, and the original ticket record in STSS 200 is flagged so that the ticket cannot be used.

At step 1009, STSS 200 connects and exchanges information with TSS 204 to make a ticket available for resale or reissue.

At step 1010, the invention determines if the user wants to exchange the ticket for another ticket. If the user does not wish to obtain another ticket step 1012 executes and the system exits after having invalidated the ticket, and notified the TSS. If, however, the user does wish to conduct and exchange step 1014 executes. Step 1014 enables the user to exchange the ticket that he/she currently owns with a new ticket (e.g., for a better seat.) Ticketing services system 204 is configured to reconcile any billing issues with the user. The exchange is a two step process involving the returning of the original ticket and issuing a new ticket.

F. Transfer of Value-Bearing Instruments (For Example, Forwarding a Ticket to Another Person Over the Internet (on Reserve)

Utilitizing one or more embodiments of the invention, the user can transfer a value-bearing instrument to another user. For example, the purchaser of a ticket may forward the ticket to another person over the Internet. Thus, the invention provides a mechanism that enables the user to transfer ownership of a value-bearing instrument to another user. This can happen in two scenarios. In the first scenario, the user indicates a desire to forward the ticket when he first purchases or reserves the ticket. In the second scenario, the ticket already exists and the user decides to transfer ownership to another party.

1. Request to Forward a New Ticket

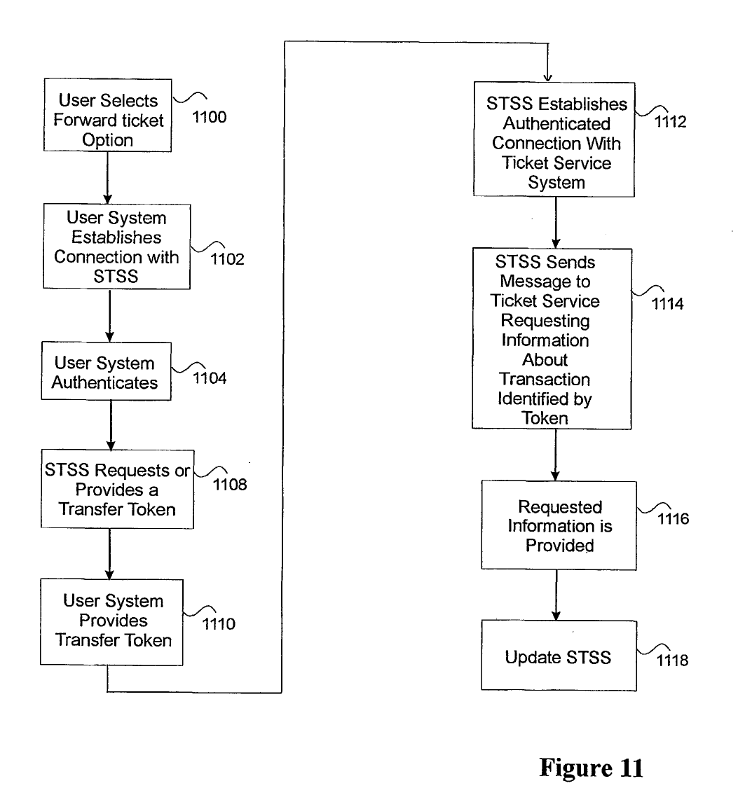

FIG. 11 is a flow diagram that shows how one embodiment of the invention provides a mechanism for forwarding a ticket to another party across a communication network. To being, user system 202 sends a message to STSS 200 to request that a ticket be issued as forwardable.

At step 1100, user system 202, on behalf of the user, interacts with ticketing services system 204 to purchase or reserve certain goods or services (e.g., select a ticket). In response, ticketing services system 204 returns a TSS confirmation token and TSS identification for the transaction that occurred between the user and ticketing services 204. TSS confirmation token uniquely identifies the goods or services that the user has reserved or purchased. Typically, the item is stored in the item database. This TSS confirmation token and detailed information about the transaction is stored into ticketing services database 218. The token can be a simple number, or some other digital form of information.

At step 1102, user system 202 establishes a connection to STSS 200, and the two systems are mutually authenticated. At step 1104, user system 202 provides the user authentication information to STSS 200. STSS 200 authenticates the user. The authentication information could be a user name and a password The TSS confirmation token is provided with the message. At step 1108, STSS 200 sends a message requesting user system 202 to provide the transfer authorization to be used by the new user obtain the ticket. At step 1110 user system 202 provides the transfer authorization specified by the user. Note: Steps 1108 and 1110 can be eliminated if secure transaction services system 200 assigns the transfer authorization itself. At step 1112, STSS 200 establishes a connection with ticketing services 204, and the two systems are mutually authenticated. Once this occurs step 1114 executes and STSS 200 sends a message to ticketing services 204 requesting information about the content provider's transaction identified by the confirmation token. At step 1116, ticketing services system 204 returns the requested information. The information comprises, but is not limited to:

TSS User Information (TUI)

TSS Ticket Content (TTC)

TSS Transaction Information (TTI)

At step 1118, transaction logic module 230 of STSS 200 updates transaction and ticket database 214 to reflect the fact that a ticket is pending for the user who is assigned to the ticket

2. Request to Forward an Existing Ticket

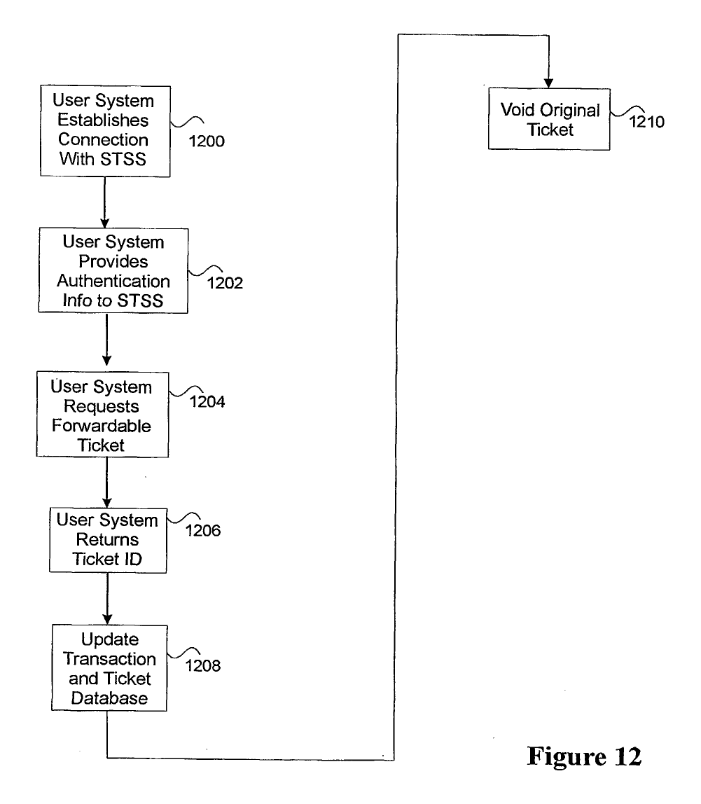

FIG. 12 is a flow diagram that shows how one embodiment of the invention provides a mechanism for forwarding a ticket to another party across a communication network after the ticket is issued. The sequence of events in this case is given below. The process begins at step 1200, where user system 202 establishes a connection to the STSS 200, and the two systems are mutually authenticated. User system 202 provides the user authentication information to STSS 200. STSS 200 authenticates the user. The authentication information could be a user name and a password (e.g., step 1202).

At step 1204, user system 202 sends a message to STSS 200 to request that a ticket be issued as a forwardable ticket. STSS 200 sends a message requesting the user system 202 to provide the ticket ID to be used to identify the transaction and the transfer authorization to be used by the new user to obtain the ticket. The transfer authorization is not needed if the secure transaction services system 200 assigns the transfer authorization itself. At step 1206, user system 202 returns the ticket ID and the transfer authorization. The transfer authorization, however, is not required if secure transaction services system 200 assigns the transfer authorization itself.

At step 1208, the transaction logic module 230 of STSS 200 updates transaction and ticket database 214 appropriately. Transaction and ticket database 214 is updated to reflect the fact that a ticket is pending for the user who is assigned to the ticket. Step 1208 may also contact ticketing services system 204 and informs it of the transaction. At step 1210, the original ticket record is flagged in the transaction and ticket database to prevent further use.

3. Obtain a Ticket on Reserve for Another User

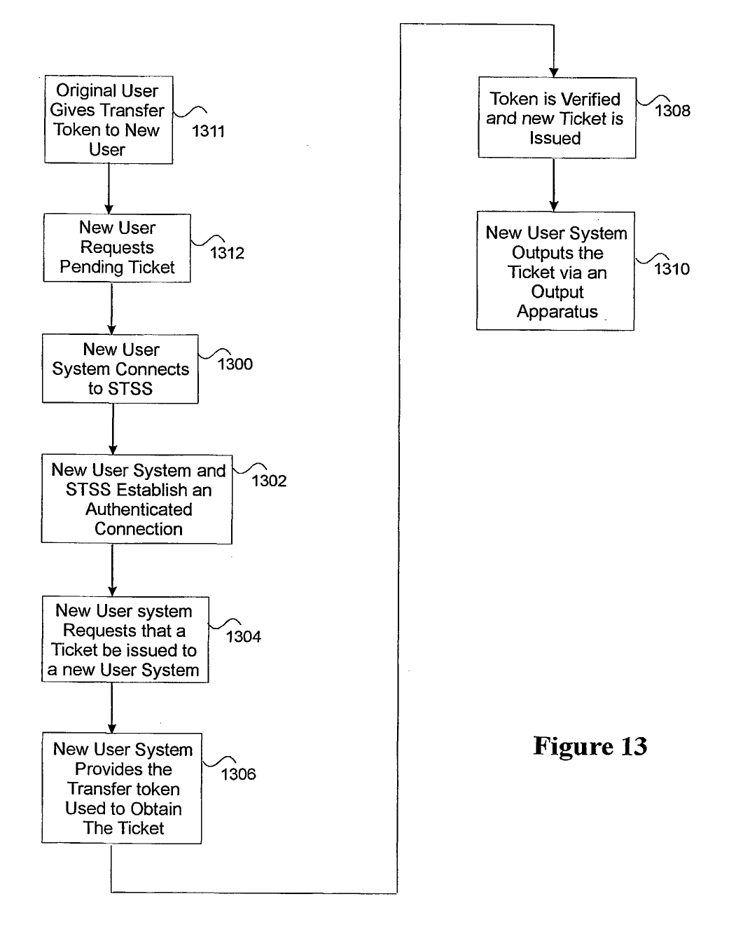

FIG. 13 illustrates how one user can obtain a ticket acquired or purchased by another user. The original user gives the transfer authorization to the new user. The following sequence of events describes how the new user gets the ticket issued. At step 1300, user system 202 for the new user establishes a connection to STSS 200, and the two systems are mutually authenticated. At step 1302, user system 202 provides the user authentication information to STSS 200. STSS 200 authenticates the user. The authentication information could be a user name and a password. At step 1304, user system 202 sends a message to STSS 200 to request that a ticket be issued to the new user. The output format of the ticket the user wants is also indicated. The output format, for example, can be a print-ready format appropriate for a printer. It could also be an output format appropriate for a smart card or personal digital appliance. At step 1306, STSS 200 sends a message requesting user system 202 to provide the transfer authorization to be used to obtain the ticket.

At step 1308, transaction logic module 230 of STSS 200 verifies the transfer authorization and issues the new ticket. STSS 200 may contact ticketing services 204 to obtain new TSS ticket content and TSS transaction information to be put into the ticket. This is optional in that ticketing services system 204 may not require this step. Ticket generator 226 in configured to create a unique secure content for the new using an appropriate ticket output format. A ticket output format may include visible data indicated by ticketing services 204 to be included in the ticket. It could also include advertisement information in the case of printed tickets. Once the ticket is generated it is returned to the new user's user system 202 and transaction and ticket database 214 is updated appropriately. At this point, step 1310 executes and new user system 202 outputs the ticket using ticket output apparatus 240. The ticket can also be output by ticketing services 204 directly via ticket output apparatus 240.

Administering Value Bearing Instruments

The following subsections describe various account management services related to administering value-bearing instruments in one or more embodiments of the invention. Examples related to tickets are provide, although it would be clear to one with ordinary skill in the art that the methods described are not limited to managing accounts associated with ticketing. Management of value-bearing instrument accounts includes, among other possible functions within the scope of this invention: the ability to manage the funds associated with user account, managing a series of related transactions for one account, providing interaction between accounts such as permitting users to resell value-bearing instruments or other digital content on a secondary market, and voiding one or a related series of transactions. Methods related to account management focus of the Account Database element of the invention. Accounting Database 216 is a secure database feature of STSS 200 that keeps track of funds on behalf of the users for the purchase/refund of tickets, services, and merchandise. Changes associated with records in account database 216 generally depend on transaction business rules 232. In one or more embodiments of the invention, a user can be associated with one or more accounts in the system.

A. Fund Management

One embodiment of the invention comprises a fund management component that enables a user to manage funds on reserve with STSS 200 or TSS 204 for the purpose of purchasing tickets. Fund management also enables the ticket holder to obtain a refund for a ticket purchased through the invention.

The fund management component comprises the following steps for adding, using, and restoring funds to a user account:

1. Adding Funds

FIG. 9B illustrates the process utilized by one embodiment of the invention to securely add funds to a user account for later use with STSS 404. At step 901, user system 202, on behalf of the user, interacts with ticketing services system 204 to add funds to the specified user account. In response, ticketing services system 204 returns a TSS confirmation token (TCT) and TSS identification (TI) for the transaction that occurred between the user and ticketing services system 204. The token can be a simple number, or some other structured, digital form of information.

At step 903, user system 202 establishes a secure connection to STSS 200, and the two systems are mutually authenticated. At step 905, user system 202 provides the user authentication information to STSS 200. STSS 200 authenticates the user. The authentication information could be, for example, a user name and a password. At step 907, user system 202 sends a message to STSS 200 to request that the user's account balance be changed (e.g., increased). The STSS may provide the TSS confirmation token with the message. At step 909, STSS 200 establishes a connection with ticketing services system 204, and the two systems are mutually authenticated.

At step 907, STSS 200 sends a message to the Ticketing Services System 204 requesting information about the transaction identified by the TSS confirmation token. While the scenario described here assumes that the information is pulled from ticketing services system 204, ticketing services system 204 could have pushed the information onto STSS 200. At step 910 ticketing services system 204 returns the requested information. The information exchanged between STSS 200 and TSS 204 will indicate that the user has provided the fund and the amount of the increase is indicated. At step 912, transaction logic module of STSS 200 performs the requested transaction by increasing the account balance of the specified account.

While this scenario assumes that ticketing services system 204 was involved in the financial transaction, the user could have also gone to the STSS 200 directly as well.

2. Using Funds

In one embodiment of the invention, the fund balance may be decremented at the time the value-bearing instrument is redeemed, or at the time the value-bearing instrument is issued, depending on the business rules associated with the transaction.

B. Managing a Series of Related Transactions

Another feature of one or more embodiments of the invention is the ability of the invention to manage a series of secure electronic related transactions. The invention can provide a user the ability to manage a portfolio of various value-bearing instruments, or of other forms of intrinsically valuable digital content. In one embodiment, this component can allow the user to receive, view, and manage all value-bearing instrument holdings, for example a set of season tickets. In one embodiment, the invention comprises one or more of the following features:

i. The ability to generate, exchange, forward and perform other functions on a given value bearing instrument or set of value-bearing instruments.

ii. The ability to create and manage contacts for the receipt, exchange, forwarding and such of a single value-bearing instrument or set of value-bearing instruments.

iii. The ability to view detailed reports that describe the user's value-bearing instrument holdings and the data associated with those holdings.

iv. The ability to attach prepaid services and products to a value-bearing instrument or set of instruments. For example, the ability to attach pre-paid parking and concession merchandise to the ticket or set of season tickets.

C. Managing Secondary Market Transactions

Another component of one or more embodiments of the invention is the ability of the invention to manage the resale of tickets in a secondary market, such as in an auction type format.

The first step in using the invention to resell value-bearing instruments in a secondary market is for the user to register and login with SSTS 200. Any user with value on account with the system may make his/her value-bearing instrument(s), or other valuable digital content, available for resale using STSS 200 as an intermediary. When requested by the selling user, STSS 200 may create a Transfer Authorization for the selling user, which the selling user or an intermediary can give to the buyer. The buyer can then exchange the Transfer Authorization for the value-bearing instrument or digital content. An example of such a transaction, in one embodiment of the invention, is using the invention to resell tickets by on-line auction.

1. Example, Reselling a Ticket on the Secondary Market

Once the user creates an account with the system, the invention enables the user to make a ticket recorded in STSS 200 available for resale. The following sequence of events comprises one or more embodiments of reselling or transferring a ticket using the invention.

1) The user purchases a ticket using the process described earlier in this document.

2) User system 202 establishes a connection to the STSS 200, and the two systems are mutually authenticated.

3) User system 202 provides the user authentication information to the STSS 200. STSS 200 authenticates the user. For example, the authentication information could be a user name and a password.

1) User system 202 sends a message to the STSS 200 to request that a ticket be resold.

2) The STSS 200 sends a message requesting user system 202 provide the Ticket ID to be used to identify the ticket.

a) STSS 200 creates a Transfer Authorization internally.

b) Transaction and Ticket Database 214 is updated appropriately, reflecting the fact that there is a transfer pending. STSS 200 contacts user system 202 to inform it about the transaction. The transfer authorization is passed to the seller or an intermediary who may resell the ticket.

The user or an intermediary may now advertise the ticket for resale on the secondary market. When the user finds a buyer, the user obtains payment, and then gives the buyer the transfer authorization. In one or more embodiments of the invention STSS 200 may act as an intermediary in the auction transaction.

Once the buyer obtains the transfer authorization he or she must contact STSS 200 to complete the transaction. Using his or her own user system 202 the buyer logs into STSS 200, and the following sequence of events occurs.

1) Buyer's user system 202 establishes a connection to the STSS 200, and the two systems are mutually authenticated.

2) Buyer's user system 202 provides the Ticket Authorization.

3) STSS 200 flags the original ticket record in ticket and transaction database 214, and records the new user information and ticket record appropriately.

Subsequently, the new owner of the ticket can use the Transfer Authorization to obtain the ticket.

Value-Bearing Instrument Record Voiding

In one or more embodiments of the invention, TSS 204 may wish to void a number of value-bearing instruments or other transactions on record with STSS 200. For example, to cancel a concert a vendor will need to cancel all tickets for the event. In another example, a vendor may discover that a purchaser's payment is invalid. In such a case, the vendor will wish to void one or more of the purchaser's transactions. In one embodiment of the invention using ticket sales as an example, ticketing services system 204 may request the voiding of one or more ticket records. The sequence of events in this example is given below.

1) Ticketing Services System 204 establishes a connection to the Secure Transaction Service System 200, and the two systems are mutually authenticated.

2) Ticketing Services System 204 sends a message to the Secure Transaction Service System 200 to request voiding of one or more tickets. The TSS provides the appropriate Ticket IDs. Secure Transaction Service System 200 verifies if this particular TSS may request this transaction on this ticket or set of tickets.

3) Transaction Logic 230 of Secure Transaction Service System 200 updates the Transaction and Ticket Database 214 to reflect the authorized request.

Verifying Value-Bearing Instruments

The following system elements are utilized by one embodiment of the invention to provide the vendor with verification of a ticket. These elements are shown in FIG. 2. Ticket output apparatus 240 provides the ticket that is an input to the verification subsystem of the invention. Ticketing services system 204 controls the ticket output apparatus. Ticket input apparatus 246 reads the ticket, and presents the data to ticket verifier system 206. In one embodiment of the invention, ticket verifier system 206 is located at the place of vending.

Ticketing Services System

Ticketing service system 204 is an agent of the vendor who provides items of value that can be redeemed using a valid ticket. Ticketing service system 204 may be configured to control the ticket output apparatus. This is the case where the vendor itself prints and distributes “secure” tickets with unique indicium added to the standard printed output.

Item database 242 keeps track of goods, services and other items of value that the ticket can be redeemed for. Ticketing service system 204 typically maintains item database 242. However, not all embodiments of the invention require item database 242

Ticket Verifier System

Ticket verifier system 206 is typically located where the ticket can be redeemed for goods and services. It has the capability to read the ticket information and to contact secure transaction services system 200 to verify the validity of the ticket. Ticket verifier system 206 is also capable of receiving the results of the ticket verification from transaction server 222, and taking appropriate action based on the results returned.

The action taken by ticket verifier system 206 after receiving the results of ticket verification is vendor dependent. For example, the component may provide a user interface to the operator to display appropriate message to the operator indicating the validity of the ticket. The component may also provide an interface to devices such as a gate or turnstile to control entry into a venue.

Ticket Output Apparatus

Ticket output apparatus 240 creates the physical form of the ticket. For example, a printer is a ticket output apparatus for printed tickets. A smart card programming device could also be ticket output apparatus.

Ticket Input Apparatus

Ticket input apparatus 246 reads the physical form of the ticket. For example, a scanner is a ticket input apparatus for printed tickets. A smart card reader could also be a ticket input apparatus.

FIG. 4a gives an example configuration. This figure shows multiple user systems 400, ticketing service system 432 and ticket verifier system 402 interacting with a ticketing service system 432.

In one embodiment of this invention, user system 400 may be a browser that is connected with the ticketing service system 432 and secure transaction services system 404.

FIG. 5 illustrates this example. In such cases, secure transaction services system 500 may download a plugin 510 into user system 508 in order to provide additional security beyond what is available through the browser. This plugin can establish a secure connection to secure transaction services system 500.

The user system 508 interacts with the ticketing service system 504 to reserve or purchase something of value through the Web. The user system 508 then communicates with secure transaction services system 500 to obtain the ticket.

As shown in FIG. 4a, at the location where the ticket is redeemed, ticket input apparatus 420 reads the ticket. The ticket verifier system 402 communicates with secure transaction services system 404 to verify the ticket.

FIG. 5 shows that the connections between secure transaction services system 500 and the Ticket Verifier System, and between secure transaction services system 500 and ticketing service system 204 do not go through the Internet. This invention, however, does not preclude the connection going through the Internet as long as the security requirements can be met through the Internet.

Ticket Verification

This invention provides three fundamental ways in which the ticket verifier system 402 can verify a ticket.

On-Line Verification

In one embodiment of the invention, tickets are verified by on-line verification. This is the most secure method described in the invention. Ticket verifier system 402 contacts the secure transaction services system 404 for ticket verification. A typical sequence of events for this function is shown in FIG. 9. In step 900 ticket verifier system 402 establishes a connection to the secure transaction services system 404, and the two systems are mutually authenticated. This step may be done only once if many tickets are to be verified.

In step 902 ticket verifier system 402 reads the indicium on the ticket using ticket input apparatus 420. Next ticket verifier system 402 performs a preliminary check to see if secure transaction services system 404 has signed the indicium. In step 906 ticket verifier system 402 sends a message to the secure transaction services system 404 to request that the ticket to be verified. The Indicium Content is sent with the message. If the transaction involves increases or decreases the funds in the user account, then the amount of the fund increase or decrease is communicated via the Indicium Content.

In step 908 secure transaction services system 404 checks to make sure the Indicium Content has been signed by the proper user as well as by ticket verifier system 402. Transaction and ticket database is checked to ensure that the ticket is still valid. If the transaction involved changes to the account fund balance, the account balance is checked and, if appropriate, the account balance is changed.

In step 910 a response is sent back by secure transaction services system 404 to ticket verifier system 402. The response is dependent on the particular ticketing application. In a typical embodiment, the response will indicate whether or not the ticket is valid and whether or not there were duplicate records of the ticket.

In the final verification step, 912, ticket verifier system 402 checks the response from secure transaction services system 404 and takes appropriate action. For example, for an invalid ticket, ticket verifier system 402 may not let the ticket holder obtain the goods or services.

Remote Verification

In another embodiment of the invention the vendor can use remote verification to validate a ticket. This method is less secure than on-line verification. FIG. 10B illustrates the remote verification process. FIG. 4c shows the elements of this embodiment of the invention.

In step 1001 a snapshot of the appropriate subset of transaction and ticket database 438 is downloaded to the ticket verifier system 402's secure local database 460. This step is performed either periodically or once in different embodiments of the invention.

Next, in step 1003 ticket verifier system 402 reads the indicium on the ticket using ticket input apparatus 420.

Ticket verifier system 402 performs a preliminary check to see if the indicium has been signed by the secure transaction services system 404. At step 1005, the ticket verifier system 02 checks for a proper signature from the STSS 404.

Step 1007 shows that ticket verifier system 402 checks to make sure the Indicium Content has been signed by the proper user as well as by ticket verifier system 402. Ticket verifier system 402 checks secure local database 460 to ensure that the Ticket State and the Item State are still valid. Handling of transactions that involve fund balance changes to the user account is not recommended in a remote verification embodiment since the transaction is not done by the secure transaction services system 404. (See e.g., step 1008.) However, it can be done if the business policy allows it. However, if user account balance changes are made off-line transaction and ticket database 438 at the secure transaction services system 404 may be updated later.

The response from the validation check is dependent on the particular invention embodiment. In a typical embodiment, the response will indicate whether or not the ticket is valid and whether or not there were duplicates.

In the final verification step, 1009, ticket verifier system 402 checks the response from secure transaction services system 404 and takes appropriate action. For example, for an invalid ticket, ticket verifier system 402 may not let the ticket holder obtain the goods or services.

Offline Verification

This method does not rely on secure transaction services system 404 or a local snapshot of transaction and ticket database 438. A local database that tracks the ticket usage is created on the fly. This is the least secure method used in an embodiment of the invention.

In this embodiment of the invention ticket verifier system 402 reads the indicium on the ticket using ticket input apparatus 420.

Ticket verifier system 402 performs the check to see if the indicium has been signed by the secure transaction services system 404. Next ticket verifier system 402 checks to make sure the ticket has not been read in yet by checking the local data base that it is dynamically creating. The ticket information is put into the local database. Handling of transactions involving fund balance change to the user account is not recommended in offline verification case since account balances can not be verified by the secure transaction services system 404, and is therefore not as secure as online methods of ticket verification. However, offline verification can be done if the business policy allows it. Transaction and ticket database 438 at the secure transaction services system 404 may be updated later.

In any embodiment of the invention a local database may be created and dynamically updated to provide offline verification as a contingency for situations where the communication with the secure transaction services system 404 is not available.

Embodiment of General Purpose Computer Environment

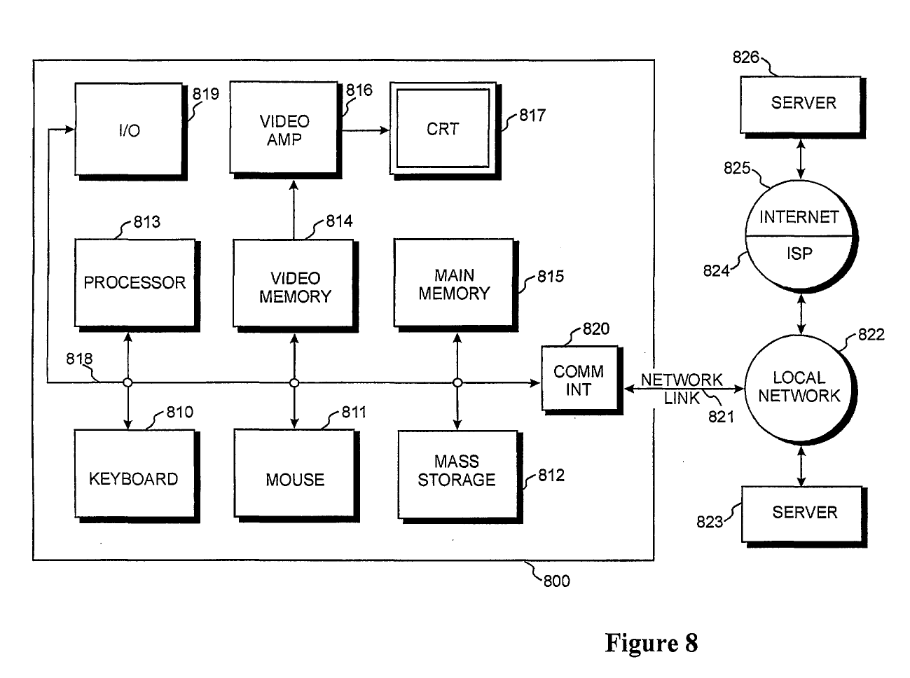

An embodiment of the invention can be implemented as computer software in the form of computer readable program code executed on one or more general-purpose computers such as the computer 800 illustrated in FIG. 8. A keyboard 810 and mouse 811 are coupled to a bi-directional system bus 818 (e.g., PCI, ISA or other similar architecture). The keyboard and mouse are for introducing user input to the computer system and communicating that user input to central processing unit (CPU) 813. Other suitable input devices may be used in addition to, or in place of, the mouse 811 and keyboard 810. I/O (input/output) unit 819 coupled to bi-directional system bus 818 represents possible output devices such as a printer or an A/V (audio/video) device.

Computer 800 includes video memory 814, main memory 815, mass storage 812, and communication interface 820. All these devices are coupled to the bi-directional system bus 818 along with keyboard 810, mouse 811 and CPU 813. The mass storage 812 may include both fixed and removable media, such as magnetic, optical or magnetic optical storage systems or any other available mass storage technology. The system bus 818 provides a means for addressing video memory 814 or main memory 815. The system bus 818 also provides a mechanism for the CPU to transferring data between and among the components, such as main memory 815, video memory 814 and mass storage 812.

In one embodiment of the invention, the CPU 813 is a microprocessor manufactured by Motorola, such as the 680X0 processor, an Intel Pentium III processor, or an UltraSparc processor from Sun Microsystems. However, any other suitable processor or computer may be utilized. Video memory 814 is a dual-ported video random access memory. One port of the video memory 814 is coupled to video accelerator 816. The video accelerator device 816 is used to drive a CRT (cathode ray tube), and LCD (Liquid Crystal Display), or TFT (Thin Film Transistor) monitor 817. The video accelerator 816 is well known in the art and may be implemented by any suitable apparatus. This circuitry converts pixel data stored in video memory 814 to a signal suitable for use by monitor 817. The monitor 817 is a type of monitor suitable for displaying graphic images.

The computer 800 may also include a communication interface 820 coupled to the system bus 818. The communication interface 820 provides a two-way data communication coupling via a network link 821 to a network 822. For example, if the communication interface 820 is a modem, the communication interface 820 provides a data communication connection to a corresponding type of telephone line, which comprises part of a network link 821. If the communication interface 820 is a Network Interface Card (NIC), communication interface 820 provides a data communication connection via a network link 821 to a compatible network. Physical network links can include Ethernet, wireless, fiber optic, and cable television type links. In any such implementation, communication interface 820 sends and receives electrical, electromagnetic or optical signals which carry digital data streams representing various types of information.

The network link 821 typically provides data communication through one or more networks to other data devices. For example, network link 821 may provide a connection through local network 822 to a host computer 823 or to data equipment operated by an Internet Service Provider (ISP) 824. ISP 824 in turn provides data communication services through the world wide packet data communication network now commonly referred to as the “Internet” 825. Local network 822 and Internet 825 both use electrical, electromagnetic or optical signals that carry digital data streams to files. The signals through the various networks and the signals on network link 821 and through communication interface 820, which carry the digital data to and from computer 800, are exemplary forms of carrier waves for transporting the digital information.

The computer 800 can send messages and receive data, including program code, through the network(s), network link 821, and communication interface 820. In the Internet example, server 826 might transmit a requested code for an application program through Internet 825, ISP 824, local network 822 and communication interface 820.

The computer systems described above are for purposes of example only. An embodiment of the invention may be implemented in any type of computer system or programming or processing environment.

Thus, a method and apparatus for generating a value-bearing instrument in an Internet or client/server environment has been described. Particular embodiments described herein are illustrative only and should not limit the present invention thereby. The claims and their full scope of equivalents define the invention.

What is claimed is:

1. A computer system adapted for the sale of value-bearing instruments within an electronic network which is in communication with a user system, comprising:
a seller computer system programmed for:
(a) receiving an order for a product from said user system, a secure transaction service computer programmed for:
(a) storing a registration of said user, including identity information for said user,
(b) establishing a secure communication channel with said user system after said order has been placed by said user system,
(c) receiving said identity information from said user system and authenticating the identity of said user, and
(d) making said product available to said user after the authenticating of the identity of said user.

2. A computer system adapted for the sale of value-bearing instruments within an electronic network which is in communication with a user system, comprising:
a seller computer system programmed for:
(a) receiving an order for a product from said user system, a secure transaction service computer programmed for:
(a) establishing a secure communication channel with said user system,
(b) registering said user via said communication channel for verification of the user's identity after placement of said order by said user system, including assigning identity information for said user, and
(c) making said product available to said user after the registering of said of said user at said secure transaction service computer.

3. A method for verification of the identity of a user in conjunction with the purchase of product through a computer network, comprising the steps of:
registering said user with a secure transaction service for establishing the identity of the user and assigning identification information for the user,
receiving an order for a product from said user by a seller of the product,
after placement of said order by said user, establishing a secure communication channel between said user and said secure transaction service,
receiving said identification information from said user via said channel by said secure transaction service for verifying the identity of said user, and
making said product available to said user only if said verifying of the identity of said user by said secure transaction service is successful.

4. A method for verification of the identity of a user in conjunction with the purchase of product through a computer network, comprising the steps of:
receiving an order for a product from said user by a seller of the product,
after placement of said order by said user, establishing a secure communication channel between said user and a secure transaction service,
registering said user with said secure transaction service to authenticate the identity of the user and assigning identification information for the user, and
making said product available to said user only after said user has been registered with said secure transaction service.

5. A method for verification of the identity of a user in conjunction with the purchase of product through a computer network, comprising the steps of:
receiving an order from a user system for said product by a seller system,
conditionally approving said order by said seller system,
said seller system providing a confirmation token to said user system, said confirmation token corresponding to said order,
transferring data relating to said order from said seller system to a secure transaction service,
receiving identification information of said user from said user system by said secure transaction service,
comparing said received identification information with identification information of registered users of said secure transaction service to determine if said user is registered with said secure transaction service,
receiving said confirmation token from said user system by said secure transaction service, and
if said user is determined to be a registered user of said secure transaction service, making said product available to said user.

6. A method for verification of the identity of a user in conjunction with the purchase of product as recited in claim 5 wherein the step of transferring data comprises sending a request for said data from said secure transaction service to said seller system and sending said data from said seller system to said secure transaction service in response to said request.

7. A method for verification of the identity of a user in conjunction with the purchase of product as recited in claim 5 wherein the step of transferring data sending said data from said seller system to said secure transaction service without receiving a request for said data from said secure transaction service.

8. A method for verification of the identity of a user in conjunction with the purchase of product through a computer network, comprising the steps of:
receiving an order from a user system for said product by a seller system,
conditionally approving said order by said seller system,
said seller system providing a confirmation token to said user system, said confirmation token corresponding to said order,
transferring data relating to said order from said seller system to a secure transaction service,
establishing a secure connection between said user system and said secure transaction service,
registering said user with said secure transaction service including assigning identification information for said user after verification of the identity of said user,
receiving said confirmation token from said user system by said secure transaction service, and
making said product available to said user.

9. A method for verification of the identity of a user in conjunction with the purchase of product as recited in claim 8 wherein the step of transferring data comprises sending a request for said data from said secure transaction service to said seller system and sending said data from said seller system to said secure transaction service in response to said request.

10. A method for verification of the identity of a user in conjunction with the purchase of product as recited in claim 8 wherein the step of transferring data sending said data from said seller system to said secure transaction service without receiving a request for said data from said secure transaction service.
